(19) United States
(12) Patent Application Publication
(10) Pub. No.: US 2026/0229206 A1
(43) Pub. Date: Aug. 6, 2026

(54) MUSICAL PIECE INFORMATION PROCESSING DEVICE, SYSTEM, MUSICAL PIECE INFORMATION PROCESSING METHOD, AND PROGRAM

(71) Applicant: AlphaTheta Corporation, Yokohama-shi, Kanagawa (JP)

(72) Inventor: Yuki Kaai, Yokohama-shi, Kanagawa (JP)

(21) Appl. No.: 19/147,025

(22) PCT Filed: Jan. 13, 2023
(86) PCT No.: PCT/JP2023/000793

§ 371 Date: Jul. 10, 2025

(51) Int. Cl. G10H 1/00

(52) U.S. Cl. CPC G10H 1/0008; G10H 2210/036; G10H 2210/125

(57) ABSTRACT

There is provided a music piece information processing device, including: a conversion unit configured to, using a converter trained to convert a feature of a first music piece into information representing a probability that a cue point is present at each position in the first music piece, convert a feature of a second music piece into the information representing the probability that the cue point is present at each position in the second music piece; and a cue point related operating unit configured to, based on the information representing the probability that the cue point is present, present cue point candidate position information in the second music piece to a user, or automatically set the cue point in the second music piece.

### TECHNICAL FIELD

The present invention relates to a music piece information processing device, a system, a music piece information processing method, and a program.

### BACKGROUND ART

For example, in DJ equipment, a playback start position in a music piece is designated, and when a predetermined operation is performed, playback of the music piece is started from the designated playback start position. The designated playback start position is also called a cue point. A technique for playing music using such cue points is described in, for example, Patent Literature 1.

### CITATION LIST

### Patent Literature(s)

Patent Literature 1: Japanese Patent No. 6263417

### SUMMARY OF THE INVENTION Problem(s) to be Solved by the Invention

However, for example, a beginner DJ with little experience often does not know where in a music piece to set cue points. Even if this is not the case, it is still a time-consuming task for a DJ to set cue points, so if part of the task could be automated, it would lead to a reduction in working hours.

An object of the invention is to provide a music piece information processing device, a system, a music piece information processing method, and a program that enable easy recognition of appropriate positions in a music piece for setting cue points.

### Means for Solving the Problem(s)

[1] A music piece information processing device, including: a conversion unit configured to, using a converter trained to convert a feature of a first music piece into information representing a probability that a cue point is present at each position in the first music piece, convert a feature of a second music piece into the information representing the probability that the cue point is present at each position in the second music piece; and a cue point related operating unit configured to, based on the information representing the probability that the cue point is present, present cue point candidate position information in the second music piece to a user, or automatically set the cue point in the second music piece.

[2] The music piece information processing device according to [1], in which for each of the first music piece and the second music piece, the information representing the probability that the cue point is present is a cue point vector at least including an element corresponding to a position in the music piece where the cue point is possibly present, and the probability that the cue point is present at each position in the music piece is represented by a value of the element of the cue point vector.

[3] The music piece information processing device according to [2], in which the cue point vector includes a plurality of elements at each position in the music piece where the cue point is possibly present, the plurality of elements corresponding to a plurality of types of settable cue points.

[4] The music piece information processing device according to any one of [1] to [3], in which the feature is an audio feature in a vicinity of a phrase change point of the music piece.

[5] The music piece information processing device according to any one of [1] to [4], in which the feature includes a feature representing a phrase pattern of the music piece.

[6] The music piece information processing device according to any one of [1] to [5], in which the feature includes a feature representing a genre of the music piece.

[7] The music piece information processing device according to any one of [1] to [6], in which the feature includes a feature representing a user attribute.

[8] The music piece information processing device according to any one of [1] to [7], in which the conversion unit is configured to convert the feature into the information representing the probability that the cue point is present, based on attribute information for the user.

[9] A system, including: a learning device configured to train a converter, which is configured to convert a feature of a music piece into information representing a probability that a cue point is present at each position in the music piece, to cause the converter to output, in response to an input of a feature of a first music piece, information representing a tendency identical to that of a cue point setting result in the first music piece by a first user; and a music piece information processing device configured to cause the converter to convert a feature of a second music piece into the information representing the probability that the cue point is present at each position in the second music piece, and configured to present cue point candidate position information in the second music piece to a second user or to automatically set the cue point in the second music piece, based on the information representing the probability that the cue point is present.

[10] The system according to [9], in which the learning device is configured to train the converter for each piece of attribute information for the first user that is set based on a position pattern of the cue point set by the first user in the first music piece, and the music piece information processing device is configured to convert the feature of the second music piece into the information representing the probability that the cue point is present at each position in the second music piece, based on attribute information for the second user.

[11] The system according to [9] or [10], in which the learning device is configured to evaluate, using normalized Discount Cumulative Gain (nDCG), whether the information output by the converter has a tendency identical to that of the cue point setting result in the first music piece by the first user.

[12] The music piece information processing device according to any one of [9] to [11] , in which for each of the first music piece and the second music piece, the information representing the probability that the cue point is present is a cue point vector at least including an element corresponding to a position in the music piece where the cue point is possibly present, and the probability that the cue point is present at each position in the music piece is represented by a value of the element of the cue point vector.

[13] A music piece information processing method, including: training a converter, which is configured to convert a feature of a music piece into information representing a probability that a cue point is present at each position in the music piece, to output information representing a tendency identical to that of a cue point setting result in a first music piece in response to an input of a feature of the first music piece by a first user; and causing the converter to convert a feature of a second music piece into the information representing the probability that the cue point is present at each position in the second music piece, and presenting cue point candidate position information in the second music piece to a second user or automatically setting the cue point in the second music piece, based on the information representing the probability that the cue point is present.

[14] A program causing a computer to convert, using a converter trained to convert a feature of a first music piece into information representing a probability that a cue point is present at each position in the first music piece, a feature of a second music piece into the information representing the probability that the cue point is present at each position in the second music piece; and to present cue point candidate position information in the second music piece to a user or to automatically set the cue point in the second music piece, based on the information representing the probability that the cue point is present.

### BRIEF DESCRIPTION OF DRAWINGS

FIG. 1 conceptually illustrates an exemplary embodiment of the invention.

FIG. 2 conceptually illustrates cue points set in a music piece.

FIG. 3 conceptually illustrates extraction of a feature vector of a music piece.

FIG. 4 illustrates an exemplary system configuration in which elements illustrated in FIG. 1 are implemented.

FIG. 5 is a schematic block diagram illustrating a functional configuration for executing a cue point prediction step in an exemplary embodiment of the invention.

FIG. 6 is a flowchart representing an example of processing when a cue point candidate position presentation function is implemented in the functional configuration illustrated in FIG. 5.

FIG. 7 is a flowchart representing an example of processing when a cue point automatic setting function is implemented in the functional configuration illustrated in FIG. 5.

FIG. 8 illustrates a user attribute classification using a cue point vector in an exemplary embodiment of the invention.

FIG. 9 illustrates an exemplary feature vector of a music piece that includes elements representing a user attribute classification.

FIG. 10 illustrates processing when a feature vector of a music piece that includes elements representing a user attribute classification is used.

FIG. 11 illustrates processing when a converter is trained for each user attribute classification.

### DESCRIPTION OF EMBODIMENT(S)

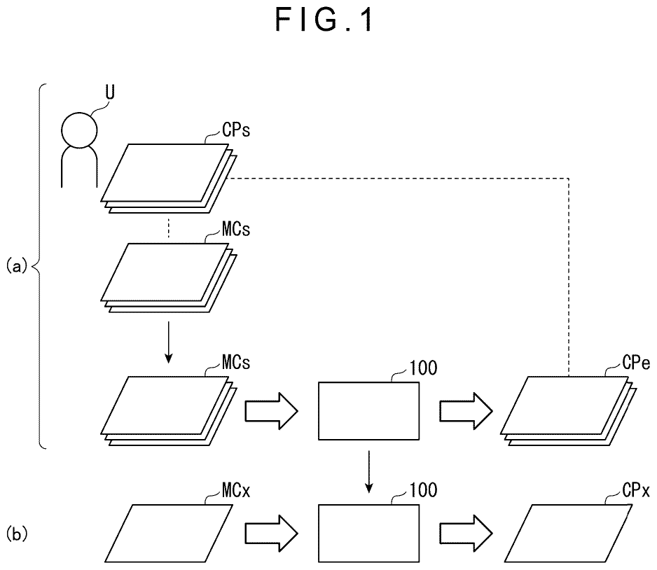

FIG. 1 conceptually illustrates an exemplary embodiment of the invention. FIG. 1(a) illustrates a learning step of a converter 100 using cue point vectors CPs that represent results of cue point setting for music pieces Mcs by a user U. The cue point vectors CPs are labels that represent cue point positions. As will be described later, the converter 100 converts a feature vector of a music piece into a cue point vector. The cue point vector is an example of information representing a probability of the presence of a cue point at each position in a music piece. In the learning step, the converter 100 is trained so that predicted cue point vectors CPe to be output in response to input of feature vectors of the music pieces MCs exhibit the same tendency as the cue point vectors CPs that are the results of cue point setting by the user U.

More specifically, in the learning step, the converter 100 is trained so that for a certain music piece included in the music pieces MCs, a cue point vector included in the predicted cue point vectors CPe and a cue point vector included in the cue point vectors CPs exhibit the same tendency. The converter 100 thus learns relationships between features of the music piece and cue point positions. As in an example described below, the cue point vector in the exemplary embodiment includes positions where the cue points are present in a music piece, specifically elements corresponding to phrase change points, and therefore it is possible to determine whether those cue point vectors have the same tendency based on the commonality of the magnitude relationship of the respective elements. As an algorithm for such a determination, for example, normalized Discount Cumulative Gain (nDCG) can be used.

FIG. 1(b) illustrates a cue point prediction step using the converter 100 trained in the learning step. In the cue point prediction step, the trained converter 100 is used to predict appropriate positions for placing cue points in a music piece MCx. The predicted cue point positions are represented by a predicted cue point vector CPx. As will be described later, the predicted cue point positions are, for example, presented to a user (who may be different from the user U at the time of learning) as cue point candidate position information, or are used in processing of automatically setting cue points.

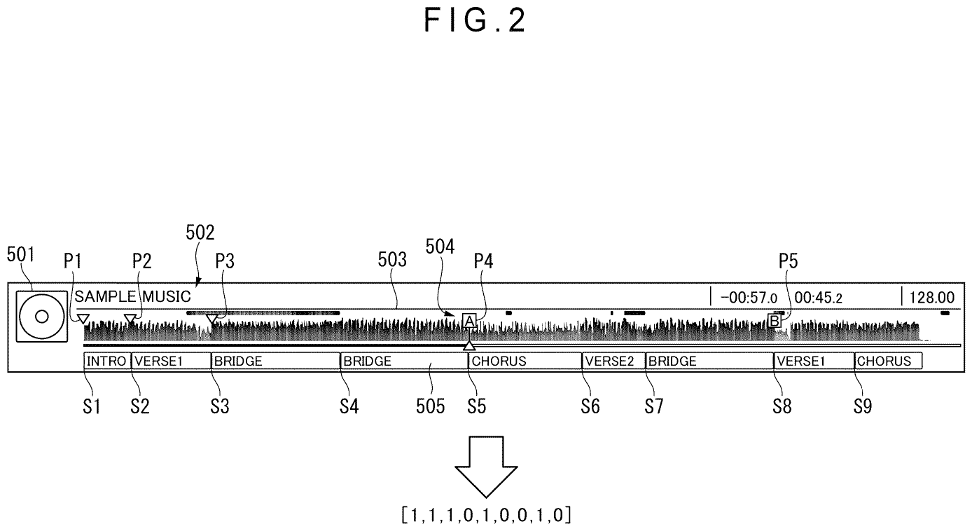

FIG. 2 conceptually illustrates cue points set in a music piece, partially illustrating a music piece information display displayed on, for example, DJ equipment. In the illustrated example, the music piece information display includes an icon image 501, a title 502, and a music waveform 503, as well as a cue point display 504 and a musical phrase display 505. Cue points P1 to P5 set in the music piece are displayed on cue point display 504. There are two types of cue points in the illustrated example. Specifically, the cue points P1, P2, and P3 are memory cues, and the cue points P4 and P5 are hot cues.

The cue point herein is a point that is recorded to play music from a specific position in a music piece in response to a user operation, which is recorded by position information in the music piece, specifically, a timestamp. In the example in FIG. 2, the memory cues are automatically sorted and recorded in chronological order. When a user operation is performed, playback pauses for a moment, and starts from the cue point with the next operation. Hot cues are assigned to cue buttons not illustrated in the drawings (for example, labeled “A” through “H”) and recorded. In response to a user operation, playback from the cue point starts immediately. As described above, multiple types of cue points may be set that differ in their recording manners or in their behavior in response to user operations.

The type of cue points is not limited to the above two examples, but may be one type, or three or more types. In addition, the operations of the various cue points are not limited to the above examples. For example, even if the cue points are named hot cues or memory cues, cue points with operations different from those described above may be set.

The musical phrase display 505 displays musical phrase sections, such as an intro, verse, bridge, and chorus, identified, for example, by a separately executed music analysis. FIG. 2 illustrates phrase change points S1 to S9 of a music piece. The phrase change points S1 to S9 represent start points or boundary points of the musical phrase sections, which are recorded by position information in the music piece, specifically, a timestamp. For example, the phrase change point S1 is the start point of the musical phrase section “intro”, and the phrase change point S2 is the boundary point between the musical phrase sections “intro” and “verse 1”. In the illustrated example, the cue point is set in the vicinity of the phrase change point. Specifically, the cue points P1, P2, P3, P4, and P5 are set in the vicinities of the phrase change points S1, S2, S3, S5, and S8, respectively. Not all phrase change points necessarily have cue points set. In the illustrated example, no cue points are set to the phrase change points S4, S6, S7, and S9. The positions where cue points may be present in a music piece are not limited to the phrase change points, but may also be beats or bars.

For example, in the learning step illustrated in FIG. 1, when the user U sets cue points in a music piece as in the example of FIG. 2, a cue point vector [1, 1, 1, 0, 1, 0, 0, 1, 0] is added to the cue point vectors CPs as a label representing the result of cue point setting in the music piece by the user U. In this example, the information representing the probability that the cue point is present at each position in the music piece is a cue point vector that includes elements corresponding to the phrase change points in the music piece. When a cue point vector is used as a label representing a result of cue point setting in a music piece by the user U, the n-th element of the cue point vector is set to “0” or “1” depending on whether the cue point is set in the vicinity of the n-th phrase change point in the music piece. More specifically, for example, if the cue point is set in a range of 500 milliseconds before and after the n-th phrase change point of the music piece, the n-th element of the cue point vector is set to “1.” If no cue point is set in the above range, the n-th element is set to “0”.

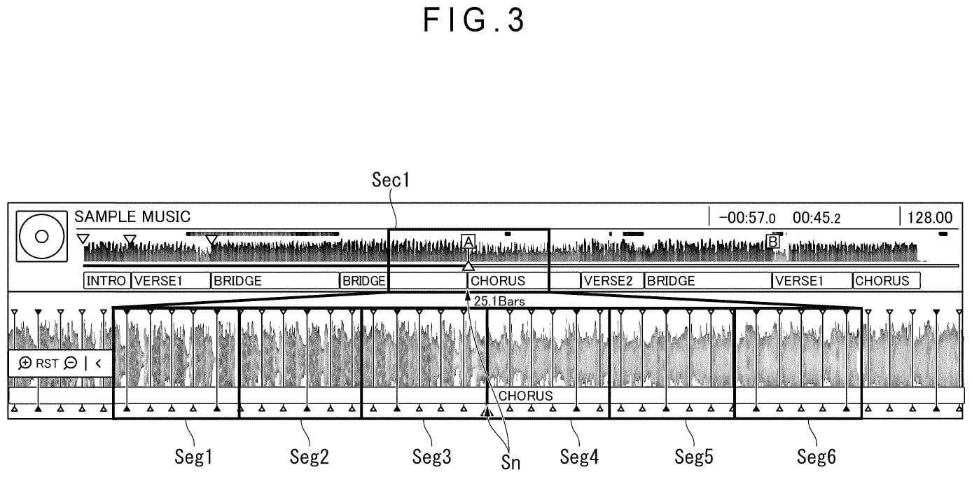

FIG. 3 conceptually illustrates extraction of a feature vector of a music piece. In the exemplary embodiment, since the cue point vector represents whether or not the cue point is set for each phrase change point of the music piece as described above, the feature vector is also extracted to include audio features in the vicinity of the phrase change point of the music piece. Specifically, for example, audio features in a section of a predetermined length before and after a phrase change point are extracted as a feature vector. In the example illustrated in FIG. 3, for a section Sec1 that includes three segments before and after a phrase change point Sn, audio features extracted from a total of six segments Seg1 to Seg6 are connected to form elements of the feature vector. The number of segments and the length of the section are not particularly limited. For example, if the bit rate of a music piece is 22.050 kHz, one segment is 59,049 samples, i.e., 2.68 seconds, and audio features for six segments, i.e., an approximately 16-second section centered on a phrase change point, may be extracted as the feature vector.

The feature vector of the music piece may include additional elements in addition to the audio features in the vicinity of each phrase change point. For example, the feature vector of the music piece may include features that represent a phrase pattern of the music piece. The phrase pattern of the music piece is a pattern in which arrangement of musical phrase sections, such as “intro→verse→bridge→chorus →verse→bridge→verse→chorus” in the music piece illustrated in FIGS. 2 and 3, is classified. For example, if p phrase patterns are set to a music piece (p≥2), the feature vector of the music piece may include a one-hot vector as elements, in which only one of the p elements is “1” and the rest are “0”. Similarly, the feature vector of the music piece may include features that represent a genre of the music piece. For example, if q genres are set to a music piece (q≥2), the feature vector of the music piece may include a one-hot vector as elements, in which only one of the q elements is “1” and the rest are “0”.

The feature vector of the music piece may also include features that represent normalized positions of cue points in the music piece. For example, if a music piece has a total length of 100 seconds and a cue point is present at a position of 25 seconds from the beginning, the feature vector of the music piece may include “0.25,” which represents the position of the cue point normalized with the total length being 1.

In the learning step of the exemplary embodiment, the converter 100 is trained so that the predicted cue point vectors CPe, which are the prediction results of the cue point positions in the music pieces by the converter 100, have the same tendency as the cue point vectors CPs, which are the results of cue point setting by the user U. For example, consider a case where for a certain music piece, the cue point setting result (ground truth) by the user U is represented by the cue point vector [1, 1, 1, 0, 1, 0, 0, 1, 0], and when the feature vector of this music piece is input to the converter 100, the predicted cue point vector [1.8, 1.2, 1.5, −0.4, 1.5, −1.2, −1.6, 1.1, 0.1] is output. In this case, the predicted cue point vector can be regarded to have the same tendency as the ground truth. This is because if the elements of the predicted cue point vector are ranked from the largest value, the result is [1, 4, 2, 7, 2, 8, 9, 5, 6], which matches the ground truth. In the cue point vector of the user setting result, the 1st, 2nd, 3rd, 5th, and 8th elements “1” are tied for 1st place, and the 4th, 6th, 7th, and 9th elements “0” are tied for last place, and in the predicted cue point vector, the 1st, 2nd, 3rd, 5th, and 8th elements are ranked high from 1st to 5th, and the 4th, 6th, 7th, and 9th elements are ranked low from 6th to 9th, so the rankings match.

A known method for calculating the degree to which two rankings match is normalized Discount Cumulative Gain (nDCG). The nDCG calculated for two rankings takes a value between 0 and 1, and is closer to 1 if the two rankings show the same tendency, and closer to 0 if the two rankings show different tendencies. The nDCG value calculated for the above two cue point vectors is 1 because the two rankings match perfectly. On the other hand, if the two rankings show completely opposite positions, the nDCG value is 0. When using nDCG in the learning step, the converter 100 is trained so that for the same music piece included in the music pieces Mcs, the nDCG calculated for the cue point vector included in the predicted cue point vectors CPe and the cue point vector included in the cue point vectors CPs is close to 1. The algorithm used in the learning step is not limited to nDCG, and any other algorithm capable of evaluating the commonality of rankings or used in supervised learning may be used.

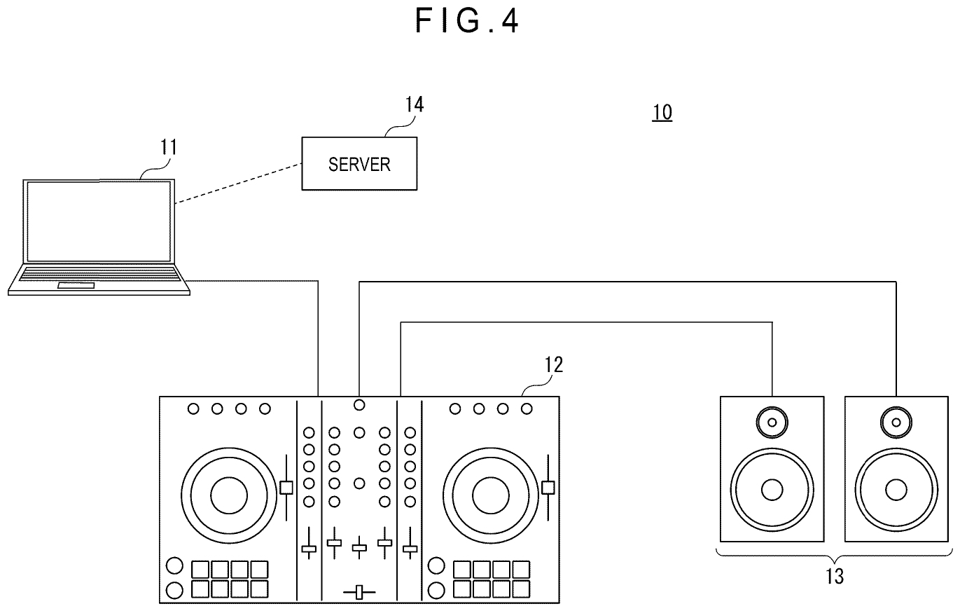

FIG. 4 illustrates an exemplary system configuration in which the elements illustrated in FIG. 1 are implemented. A system 10 illustrated in FIG. 4 includes a personal computer (PC) 11, a DJ controller 12, a speaker 13, and a server 14. The PC 11 is a device that stores, processes, and reproduces audio data of a music piece. The PC 11 is not limited to a PC, and may be a terminal device such as a tablet or a smartphone. The DJ controller 12 is coupled to the PC 11 via a communication means such as a universal serial bus (USB). The DJ controller 12 receives a user operation input related to playback of a music piece through a channel fader, a cross fader, a performance pad, a jog dial, various knobs, buttons, or the like. The audio data is reproduced using the speaker 13 in accordance with the control from the DJ controller 12. The server 14 is coupled to the PC 10 via a network as necessary, and provides various functions. The functions described below are implemented in software in the PC 11, the DJ controller 12 or the server 14 by a computer operating according to a program stored in a memory.

For example, the functions for executing the learning step illustrated in FIG. 1, i.e., the converter 100 and the determination function for learning, are implemented in the server 14 or the like. In this configuration, the server 14 collects the results of the cue point setting operation for the music pieces performed by the user U on the PC 11 or DJ controller 12 coupled via a network, as the cue point vectors CPs, and uses these results together with the feature vectors of the music pieces (MCs) extracted and collected separately, to train the converter 100. In another example, the converter 100 and the determination function for learning may be implemented in the PC 11, and the learning step may be executed by downloading some or all of the cue point vectors CPs stored in the server 14.

The function for executing the cue point prediction step illustrated in FIG. 1 is implemented in, for example, in the PC 11. In this configuration, for example, when a user operates the PC 11 or the DJ controller 12 to select the music piece MCx, cue point candidate position information is presented or automatic setting of the cue points is executed, by using the predicted cue point vector CPx obtained by inputting the feature vector of the music piece MCx into the converter 100. Some or all of these processes may be executed by the server 14 coupled to the PC 11 via a network. At least part of the cue point prediction step may be executed in advance for a music piece playable by a user. For example, the predicted cue point vector CPx obtained by a user inputting a feature vector of a playable music piece into the converter 100, or cue point candidate position information to be presented or information for automatically setting cue points each based on the predicted cue point vector Cpx may be stored in the PC 11, the DJ controller 12, or the server 14 in association with each music piece.

The configuration of the system in which the elements illustrated in FIG. 1 are implemented is not limited to the above examples. In another example, instead of or together with the PC 11, the system may include DJ equipment such as a mixer or an all-in-one DJ system (digital audio player with communication and mixing functions), and the learning step and cue point prediction step may be at least partially executed on the DJ equipment. The learning step and the cue point prediction step need not be executed on a single device, but may be executed in a distributed manner across multiple devices.

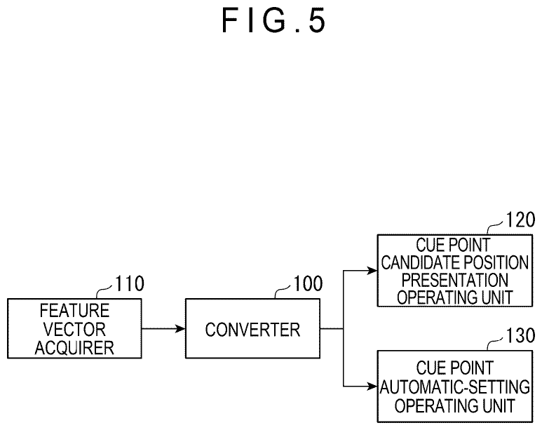

FIG. 5 is a schematic block diagram illustrating a functional configuration for executing the cue point prediction step in an exemplary embodiment of the invention. In the illustrated example, a feature vector acquirer 110, the converter 100 (conversion unit), a cue point candidate position presentation operating unit 120, and a cue point automatic-setting operating unit 130 are implemented as functions. The feature vector acquirer 110 acquires a feature vector of a music piece to be processed in the cue point prediction step. The feature vector of the music piece is extracted, for example, by music analysis executed in advance, and is stored in the PC 11 or the server 14 in association with the music piece. Alternatively, the feature vector acquirer 110 may include a music analysis function and extract a feature vector from audio data or data of a musical phrase section of a music piece.

The converter 100 (conversion unit) converts the feature vector of the music piece acquired by the feature vector acquirer 110 into a cue point vector that represents cue point positions in the music piece. As described above, the converter 100 used in the cue point prediction step is trained through the learning step, and is capable of outputting a cue point vector that represents cue point positions predicted to be appropriate for the input of the feature vector of the music piece. For example, consider a case where the converter 100 receives a feature vector of a music piece and outputs a cue point vector [1.8, 1.2, 1.5, −0.4, 1.5, −1.2, −1.6, 1.1, 0.1]. If the top 5 elements are converted to “1” and the rest to “0”, a cue point vector [1, 1, 1, 0, 1, 0, 0, 1, 0] is obtained, and the prediction result is that it is appropriate to set cue points at the 1st, 2nd, 3rd, 5th, and 8th phrase change points of the music piece. In the above example, the number of top elements to be set as “1” may be selectable by a user, for example, or may be automatically determined according to an upper limit of the number of cue points that can be set. As another example, an average value of all elements of the cue point vector or another predetermined value may be set as a reference value, and elements equal to or greater than the reference value may be converted to “1” and elements less than the reference value may be converted to “0.” It is not indispensable to express the prediction result using “1” and “0”.

The cue point candidate position presentation operating unit 120 and the cue point automatic-setting operating unit 130 are each an exemplary cue point related operating unit that executes processing using a cue point vector acquired by the converter 100, and only one of them may be implemented, or both may be implemented. The cue point candidate position presentation operating unit 120 presents, to a user, the positions of the phrase change points in the music piece represented by the cue point vector, as the cue point candidate position information. The cue point candidate position information is displayed on a display of the PC 11 or the DJ controller 12 in a form similar to the cue point display 504 of the music piece information display illustrated in FIG. 2, for example. On the other hand, the cue point automatic-setting operating unit 130 automatically sets cue points at positions in the music piece that are predicted in the cue point vector to be suitable for setting cue points. The automatically set cue points are displayed on the display of the PC 11 or the DJ controller 12 in the form of the cue point display 504 of the music piece information display illustrated in FIG. 2, for example.

According to the above-described processing of the cue point candidate position presentation operating unit 120, a user can select a position in the music piece at which the cue point is to be set from among the candidates presented in advance. Similarly, according to the above-described processing of the cue point automatic-setting operating unit 130, a user can select a cue point to use by trying out playback from each of the cue points automatically set in the music piece. In either case, by predicting appropriate cue points based on the cue point vector, even a beginner can easily recognize appropriate positions in the music piece for setting the cue points.

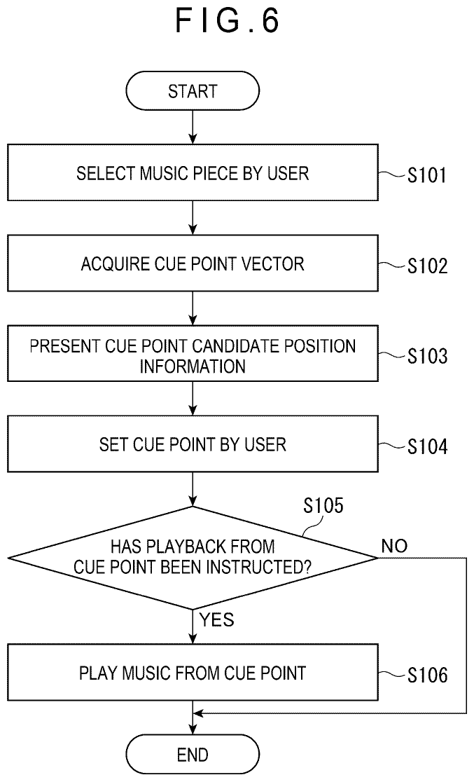

FIG. 6 is a flowchart representing an example of processing when a cue point candidate position presentation function is implemented in the functional configuration illustrated in FIG. 5. In the illustrated example, first, a user selects a music piece by operating the PC 11 or the DJ controller 12 (Step S101), and a cue point vector is acquired for the selected music piece (Step S102). In this step, for example, the feature vector acquirer 110 estimates cue point positions from a feature vector of the selected music piece. Alternatively, the feature vector acquirer 110 may read out a cue point vector previously created by the converter 100. When the cue point vector of the selected music piece is acquired, the cue point candidate position presentation operating unit 120 presents, to the user, the cue point candidate position information using the display of the PC 11 or the DJ controller 12 (Step S103). The user sets a cue point referring to the information presented and the PC 11 or the DJ controller 12 (Step S104). After that, when playback from the cue point is instructed by a user operation (Step S105), the PC 11 or the DJ controller 12 plays music from the cue point instructed (Step S106).

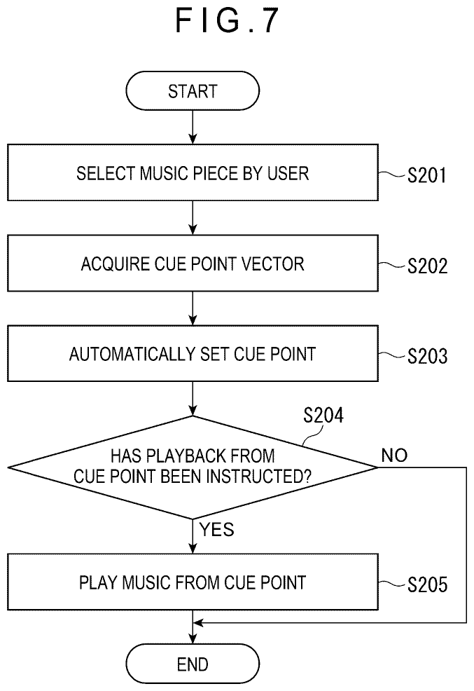

FIG. 7 is a flowchart representing an example of processing when a cue point automatic setting function is implemented in the functional configuration illustrated in FIG. 5. In the illustrated example, similarly to the example of FIG. 7, a user selects a music piece (step S201), and a cue point vector of the selected music piece is acquired (step S202). When the cue point vector of the selected music piece is acquired, the cue point automatic-setting operating unit 130 automatically sets cue points in the music piece (step S203). The cue point positions automatically set are presented to the user by being displayed on the display of the PC 11 or the DJ controller 12. The user operates the PC 11 or the DJ controller 12 while referring to the information presented thereon to instruct playback from the cue point (step S204). When playback from the cue point is instructed by the user, the PC 11 or the DJ controller 12 plays music from the cue point instructed (step S205).

The algorithm described so far is an algorithm that predicts a general cue point setting tendency from the cue point setting tendencies of a large number of sampled users. In the following, an algorithm for cue point prediction using a user attribute is described. The algorithm for cue point prediction using the user attribute is an algorithm that predicts a cue point setting tendency reflecting preferences of a specific user (an individual), based on statistical data of the specific user's cue point setting tendencies.

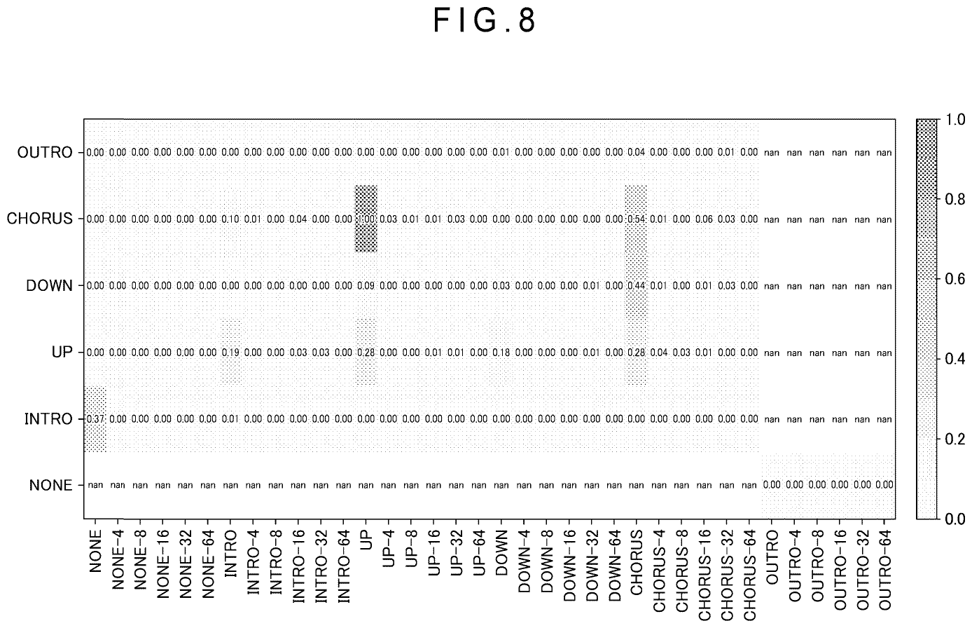

In an algorithm for cue point prediction using a user attribute according to an exemplary embodiment of the invention, a score representing a cue point prediction probability is obtained for each phrase change point and each beat position 4, 8, 16, 32, or 64 beats before that phrase change point, based on a frequency distribution for phrase change point types of the set cue points. FIG. 8 illustrates a user attribute classification using a cue point vector in an exemplary embodiment of the invention. The graph illustrated in FIG. 8 illustrates a frequency distribution for phrase change point types of cue points set in a music piece by a specific user. In the graph, the vertical axis indicates the musical phrase section after the phrase change point, and the horizontal axis indicates the musical phrase section before the phrase change point and the number of beats between the cue point set in the vicinity of the phrase change point and the phrase change point. For example, an area where “CHORUS” on the vertical axis intersects with “INTRO-16” on the horizontal axis indicates a frequency at which the cue point is set 16 beats before the phrase change point positioned after “INTRO” and before “CHORUS”. The highest frequency is in an area where “CHORUS” on the vertical axis intersects with “UP” on the horizontal axis, and the next highest frequency is in an area where “CHORUS” on the vertical axis intersects with “CHORUS” on the horizontal axis.

The score obtained by the cue point prediction algorithm without using the user attribute is normalized to [0, 1], and the score obtained by the cue point prediction algorithm with the user attribute is also normalized to [0, 1]. The sum of these scores for each beat is the score for that beat. The predicted cue point positions are determined in descending order of the scores. It should be noted that the scores may be weighted and summed, or the scores may be multiplied.

Regarding the user attribute, a distribution representing at which transition (from one phrase to another) a user is likely to set a cue point, i.e., a statistical analysis of cue points, is taken into consideration. Further, a music genre the user uses frequently may be taken into consideration. Furthermore, the positions at which the user often sets cue points in a music piece may be taken into consideration. For example, a tendency that the user is more likely to set cue points in the first half of a music piece and also sets cue points in the second half, etc. may be represented using a vector. For a single cue point, a position in a music piece can be represented using a value (0, 1). For multiple cue points, the entire music piece may be divided into n parts and cue points may be represented using an n-dimensional vector. For example, a music piece can be divided into eight parts and cue points can be represented using an eight-dimensional vector. Specifically, if there is an eight-dimensional vector of [1, 0.3, 0.6, 0.5, 0.1, 0.1, 0.4, 0.3], it is understood that the user invariably sets a cue point at the beginning of a music piece and also sets cue points in the latter half. Users can be classified by clustering such data. In addition, an era of music pieces the user uses frequently and types of cue points the user set (e.g., a memory cue, hot cue, loop, color, etc.) may be used to classify users.

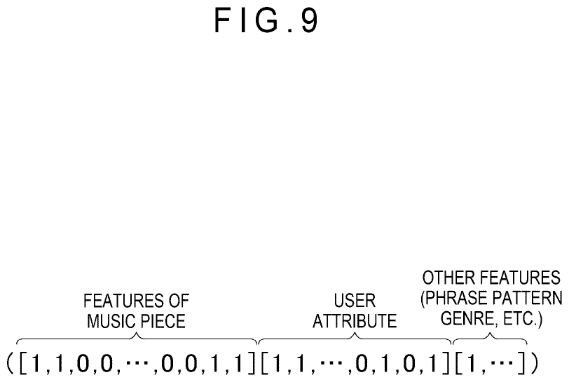

FIG. 9 illustrates an exemplary feature vector of a music piece that includes elements representing a user attribute classification. In the above example, the user attribute classification may be included as elements of the feature vector of the music piece, for example. In this case, the feature vector of the music piece includes elements representing the user attribute in addition to the vector elements representing the features of the music piece. As described above, the feature vector of the music piece may include the features representing the phrase pattern of the music piece and the features representing the genre of the music piece. A vector representing the user attribute classification is specifically a user vector created from types of phrase change points at which cue points are set. In the example illustrated in FIG. 8, a user vector of up to 216 dimensions is created from the combinations of the musical phrase section after the phrase change point (6 ways), and the musical phrase section before the phrase change point and the number of beats between the phrase change point and the cue point set in the vicinity of the phrase change point (36 ways). Alternatively, a user vector may be created by adding up data per cue point type. For example, in the example of FIG. 8, if the data for the two types of the hot cue and memory cue are added together, a user vector with up to 432 dimensions will be created. In addition, a user vector may be created using, for example, a proportion of a type of genre of music pieces owned by a user. The dimension of the user vector may be reduced using SVM, convolution, or the like. When the capacity of the user vector is large, the increase in the amount of calculation can be inhibited by reducing the dimension.

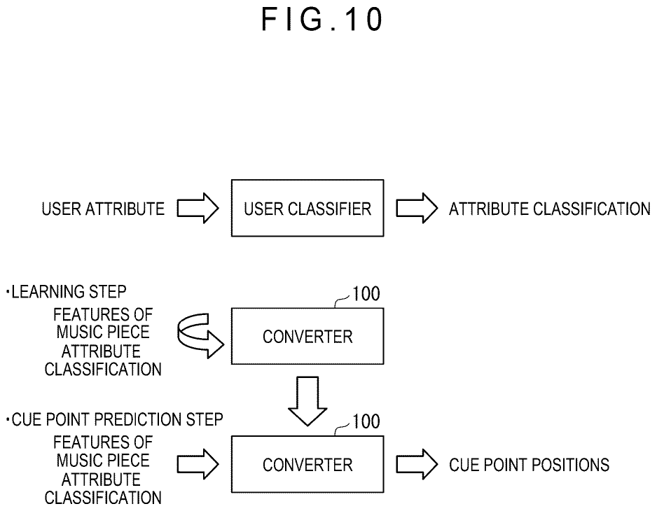

FIG. 10 illustrates processing when a feature vector of a music piece that includes elements representing a user attribute classification is used. A user classifier in the illustrated example converts user attribute classification information, such as that illustrated in FIG. 8, into an attribute classification with reduced dimensions using SVM, convolution, or the like. In the learning step, the converter 100 is trained using the attribute classification created by the user classifier for the user U (see FIG. 1) who provided the cue point setting result, and the features of the music piece for which cue points are to be set. In the cue point prediction step, the attribute classification created by the user classifier for a user who will use the cue point prediction result and the features of the music piece for which cue points are to be predicted are input to the converter 100 to predict cue point positions. For example, by setting a finite number of attribute classifications in advance, it is possible to create an appropriate amount of information regarding the user classification.

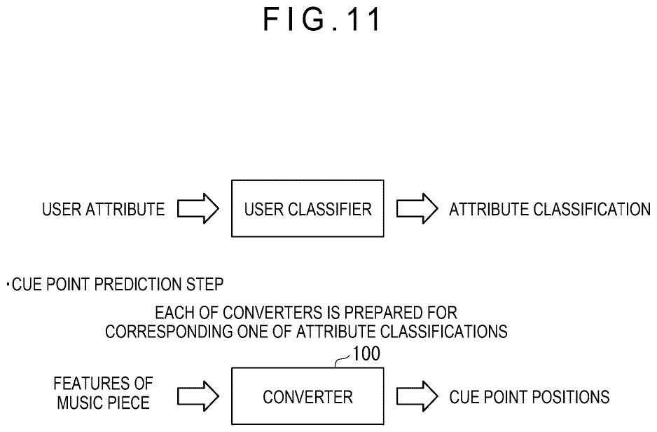

FIG. 11 illustrates processing when a converter is trained for each user attribute classification. In the illustrated example, multiple converters 100 are prepared, that is, each of the converters 100 is prepared for the corresponding one of user attribute classifications. Each converter 100 is trained according to the corresponding attribute classification created by the user classifier for the user U (see FIG. 1) who provided the cue point setting result. In the cue point prediction step, cue point positions are predicted from the features of the music piece using each converter 100 trained according to the corresponding attribute classification created by the user classifier for a user who will use the cue point prediction result.

As other examples, the converter 100 may be trained for each type of cue point in the learning step illustrated in FIG. 1. As described with reference to FIG. 2, multiple types of cue points may be included, such as hot cues and memory cues. In the above example, the cue point vector is defined without distinguishing between these types of cue points, but the cue point vector may be defined to represent the type of cue point in addition to the position of the cue point in the music piece. For example, for a music piece in which hot cues and memory cues are set as illustrated in FIG. 2, a cue point vector of [1, 0, 1, 0, 1, 0, 0, 0, 0, 1, 0, 0, 0, 0, 0, 1, 0, 0] may be defined. In this example, an odd-numbered element of the cue point vector represents whether the cue point of the memory cue is set in the vicinity of the phrase change point, and an even-numbered element represents whether the cue point of the hot cue is set in the vicinity of the phrase change point.

### EXPLANATION OF CODES

10 . . . system, 12 . . . DJ controller, 13 . . . speaker, 14 . . . server, 100 . . . converter (conversion unit), 110 . . . feature vector acquirer, 120 . . . cue point candidate position presentation operating unit, 130 . . . cue point automatic-setting operating unit, 501 . . . icon image, 502 . . . title, 503 . . . music waveform, 504 . . . cue point display, 505 . . . musical phrase display, P1 to P5 . . . cue point, S1 to S9 . . . phrase change point, Sec1 . . . section, Seg1 to Seg6 . . . segment, Sn . . . phrase change point

1. A music piece information processing device, comprising:
a conversion unit configured to, using a converter trained to convert a feature of a first music piece into information representing a probability that a cue point is present at each position in the first music piece, convert a feature of a second music piece into the information representing the probability that the cue point is present at each position in the second music piece; and
a cue point related operating unit configured to, based on the information representing the probability that the cue point is present, present cue point candidate position information in the second music piece to a user, or automatically set the cue point in the second music piece.

2. The music piece information processing device according to claim 1, wherein for each of the first music piece and the second music piece, the information representing the probability that the cue point is present is a cue point vector at least including an element corresponding to a position in the music piece where the cue point is possibly present, and the probability that the cue point is present at each position in the music piece is represented by a value of the element of the cue point vector.

3. The music piece information processing device according to claim 2, wherein the cue point vector includes a plurality of elements at each position in the music piece where the cue point is possibly present, the plurality of elements corresponding to a plurality of types of settable cue points.

4. The music piece information processing device according to claim 1, wherein the feature is an audio feature in a vicinity of a phrase change point of the music piece.

5. The music piece information processing device according to claim 1, wherein the feature includes a feature representing a phrase pattern of the music piece.

6. The music piece information processing device according to claim 1, wherein the feature includes a feature representing a genre of the music piece.

7. The music piece information processing device according to claim 1, wherein the feature includes a feature representing a user attribute.

8. The music piece information processing device according to claim 1, wherein the conversion unit is configured to convert the feature into the information representing the probability that the cue point is present, based on attribute information for the user.

9. A system, comprising:
a learning device configured to train a converter, which is configured to convert a feature of a music piece into information representing a probability that a cue point is present at each position in the music piece, to cause the converter to output, in response to an input of a feature of a first music piece, information representing a tendency identical to that of a cue point setting result in the first music piece by a first user; and
a music piece information processing device configured to cause the converter to convert a feature of a second music piece into the information representing the probability that the cue point is present at each position in the second music piece, and configured to present cue point candidate position information in the second music piece to a second user or to automatically set the cue point in the second music piece, based on the information representing the probability that the cue point is present.

10. The system according to claim 9, wherein
the learning device is configured to train the converter for each piece of attribute information for the first user that is set based on a position pattern of the cue point set by the first user in the first music piece, and
the music piece information processing device is configured to convert the feature of the second music piece into the information representing the probability that the cue point is present at each position in the second music piece, based on attribute information for the second user.

11. The system according to claim 9, wherein the learning device is configured to evaluate, using normalized Discount Cumulative Gain (nDCG), whether the information output by the converter has a tendency identical to that of the cue point setting result in the first music piece by the first user.

12. The system according to claim 9, wherein for each of the first music piece and the second music piece, the information representing the probability that the cue point is present is a cue point vector at least including an element corresponding to a position in the music piece where the cue point is possibly present, and the probability that the cue point is present at each position in the music piece is represented by a value of the element of the cue point vector.

13. A music piece information processing method, comprising:
training a converter, which is configured to convert a feature of a music piece into information representing a probability that a cue point is present at each position in the music piece, to output information representing a tendency identical to that of a cue point setting result in a first music piece in response to an input of a feature of the first music piece by a first user; and
causing the converter to convert a feature of a second music piece into the information representing the probability that the cue point is present at each position in the second music piece, and presenting cue point candidate position information in the second music piece to a second user or automatically setting the cue point in the second music piece, based on the information representing the probability that the cue point is present.

14. A non-transitory tangible storage medium storing a program causing a computer
to convert, using a converter trained to convert a feature of a first music piece into information representing a probability that a cue point is present at each position in the first music piece, a feature of a second music piece into the information representing the probability that the cue point is present at each position in the second music piece; and
to present cue point candidate position information in the second music piece to a user or to automatically set the cue point in the second music piece, based on the information representing the probability that the cue point is present.
